(19) United States
(12) Patent Application Publication
(10) Pub. No.: US 2004/0150202 A1
(43) Pub. Date: Aug. 5, 2004

(54) Inflator for air bag

(76) Inventor: Yuzo Goto, Himeji-shi (JP)

Correspondence Address: BIRCH STEWART KOLASCH & BIRCH, PO BOX 747, FALLS CHURCH, VA, 22040-0747, US

(21) Appl. No.: 10/713,260

(22) Filed: Nov. 17, 2003

Related U.S. Application Data
(60) Provisional application No. 60/427,955, filed on Nov. 21, 2002.

(30) Foreign Application Priority Data
Nov. 18, 2002 (JP) 2002-333622

(51) Int. Cl. B60R 21/28

(52) U.S. Cl. 280/740

(57) ABSTRACT

The present invention provides an inflator for an air bag which concentrates the discharging direction of a gas in one direction toward an air bag and does not allow jumping of the inflator even due to malfunction thereof before installation to a vehicle, and which further allows easy and reliable connection of the air bag and the inflator. An inflator for an air bag is constituted to include a gas discharge portion 20 provided with an annular portion with plural first gas discharge ports 22 formed therein, and a diffuser portion 40 removably mounted only in the vicinity of the first gas discharge ports, the diffuser member 40 is provided with a passage forming portion 50, and one or two or more second gas discharge ports 45 for discharging a gas of a passage 46 in the radial direction of an inflator housing are formed unevenly on one portion of the passage forming portion in the circumferential direction thereof.

### TECHNICAL FIELD WHERE THE INVENTION BELONGS

The present invention relates to an inflator for an air bag mounted to a vehicle, and in particular to an inflator for an air bag with an improved portion of the inflator positioned in the vicinity of a gas discharging portion thereof, and an air bag apparatus using the inflator.

### BACKGROUND ART

As an inflator for an inflating type safety system of an automobile, in order to optimally protect a passenger in accordance with a position of a seat in a vehicle such as a driver side, a passenger side and the like, various kinds of inflators such as an air bag inflator for a driver side, an air bag inflator for a passenger side, an inflator for an air bag for a side collision, an inflator for a curtain air bag, an inflator for a knee-bolster, an inflator for an inflatable seat belt, an inflator for a tubular system, an inflator for a pretensioner are known. The inflator for a curtain air bag of these inflators is for, when a vehicle receives an impact acting from the transverse direction thereof, instantaneously inflating and developing a curtain-like air bag with a thickness of about several centimeters on a window side of the vehicle to protect the head of a passenger, and the inflator for an air bag for an side collision is for protecting the breast or the head of a passenger from an impact acting from the transverse direction like the inflator for a curtain air bag.

Various kinds of inflators are required to be reduced in size and weight from a demand for weight reduction of a vehicle itself, and they are also required for improvement in workability, simplification of manufacturing steps, and improvement in safety at activation.

In particular, in the inflator for an air bag for an side collision or the inflator for a curtain air bag, in view of a space in a mounting place, it is desirable that the inflator is formed in an elongated shape as a whole and the inflator is installed such that the axis of a housing thereof is oriented in the vertical direction, when the inflator is disposed in a vehicle. In this case, it is desirable that the inflator is formed as an inflator which exhausts a gas for inflating an air bag in a direction orthogonally to the axial direction (the axial direction of the housing). Further, the air bag inflator for a passenger side is also required to be installed inside a dashboard in the transverse direction, when it is formed to be long in the axial direction as a whole. When installation is made in this manner, it is preferable that the inflator is formed to exhaust a gas for inflating an air bag in a direction orthogonally to the axial direction (the axial direction of a housing) and the discharging direction of the gas is concentrated in one direction towards the air bag to inflate the air bag swiftly and efficiently with the gas discharged. In this connection, considering safety too, even such an inflator as constituted to concentrate a gas in one direction and discharge the same must be formed such that the inflator does not jump with a propelling force due to a gas concentrated and discharged before the inflator is assembled in a vehicle.

Conventionally, as the technique for concentrating a discharging direction of a gas in one direction, there are JP-A No. 9-39709 and DE-B No. 1985044. In the JP-A No. 9-39709, there is a technique where a gas generator 2 which exhausts a gas radially in all directions is installed inside a module case 1 or a pressure steel tube 13, and the discharging direction of a gas is concentrated in one direction inside the module case 1 or the pressure steel tube 13. In the case of accompanying such a constitution, as the module case or the pressure steel tube accommodates the entire of the gas generator, the whole volume thereof eventually becomes large. When the inflator is mounted in a vehicle, inconvenience occurs regarding a mounting space therefor. Further, in the DE-B No. 1985044, there is disclosed a technique where a gas discharged from a diffuser mounted at an end portion of a gas generator is introduced into air bags 5, 6 via a passage 59 and a tube 58 branched off in two portions. When formation is made in this manner, as a tube 53 forming the passage 59 has a structure covering even a main body portion of a gas generator 2, and a distal end of the tube 53 is branched off in two portions, inconvenience occurs regarding an installation space thereof, when mounting to a vehicle is conducted.

Further, an inflator and an air bag are required to be connected to introduce a gas discharged from the inflator into the air bag, but it is desirable that the connection can be made easily and reliably. However, the inflators provided conventionally have still rooms to be improved regarding this connection.

### DISCLOSURE OF THE INVENTION

An object of the present invention is to provide an inflator for an air bag which can concentrate the discharging direction of a gas exhausted from the inflator in one direction toward a air bag for inflating the air bag swiftly and efficiently, and does not allow the inflator to jump even due to malfunction before installation of the inflator in a vehicle, and which further allows easy and reliable connection of the air bag and the inflator.

In order to solve the above problem, the present invention provides an inflator for an air bag constituted to include an inflator housing that accommodates at least one of a pressurized gas and a gas generating agent which burns to generate a gas, a gas discharge portion provided with an annular portion formed with plural first gas discharge ports for discharging a gas of the inflator housing, and a diffuser member which covers an outer surface of the gas discharge portion and is mounted as a separate member only in the vicinity of the first gas discharge ports, wherein the diffuser member is provided with a passage forming portion forming a passage for guiding a gas discharged from the first gas discharge ports in a circumferential direction between the diffuser member and the gas discharge portion, and one or two or more second gas discharge ports for discharging a gas of the passage in the radial direction of the inflator housing are formed unevenly on one portion of the passage forming portion along the circumferential direction thereof.

In the inflator of the present invention, one which can be used as a gas source for inflating an air bag may be a pressurized gas or it may be a solid gas generating agent which is burnt to generate a gas, or both of them can be used as the gas source. For this reason, at least one of a pressurized gas and a gas generating agent which generates a gas due to combustion, which are the gas source is accommodated inside the inflator housing. Particularly, in the case of using the gas source including a pressurized gas, a rupturable plate for sealing the pressurized gas inside the housing is also required usually and a rupturing means (for example, an igniter or the like) for rupturing the rupturable plate at activation is required too.

In addition to the case in which the gas discharge portion provided with the annular portion formed with the plural first gas discharge ports is provided to the inflator housing as a separate member, the gas discharge portion may be formed integrally with the inflator housing. In particular, in the case in which the gas discharge portion is formed integrally with the inflator housing, it generally becomes difficult to define the same portion, but it is desirable in order to achieve size reduction of the inflator that a narrower range which can cover a whole range formed with the first gas discharge ports is defined as the gas discharge portion.

Further, it is desirable that the plural first gas discharge ports formed in the annular portion of the gas discharging portion are formed evenly in the circumferential direction of the annular portion. That is, it is preferable that at least two of the plural first gas discharge ports are arranged at positions symmetrical to each other in the widthwise direction or positions near thereto. For example, when two or three or more first gas discharge ports are provided, there are arranged on an outer peripheral portion of the gas discharge portion at equal intervals along the circumferential direction. It is desirable that, when three first gas discharge ports are provided, the three exhausting ports are arranged equally at an angle of 120°, and when four gas exhaust ports are provided, they are arranged equally at an angle of 90°. When five or more are provided, arrangement is conducted in the same manner. When formation is made in this manner, even if malfunction occurs before a diffuser member is mounted such as during transportation/storage, a propelling force due to exhaust of a gas from the first gas discharge ports is cancelled and therefore an accident that the inflator jumps as a rocket can be prevented from occurring.

Then the inflator of the present application is constituted to include the diffuser member mounted as a separate member to cover only an outer surface in the vicinity of the gas discharge portion. This diffuser member is provided between the same and the gas discharge portion with a passage forming portion forming a passage for guiding a gas discharged from the first gas discharge ports in the circumferential direction of the gas discharge portion, and one or two or more second gas discharge ports for discharging a gas of the passage in the radial direction of the inflator housing are formed in one portion of the passage forming portion unevenly in the circumferential direction. The gas discharged from the first gas discharge ports flows inside the passage formed by the passage forming portion of the diffuser member to be exhausted from the second exhausting ports in one portion of the passage forming portion unevenly in the circumferential direction thereto, so that the discharging direction of the gas exhausted from the inflator can be concentrated in one direction towards the air bag. Further, since the gas is concentrated in one direction and discharged by the diffuser member, when the air bag is installed to develop in the discharging direction of the gas, the development can be conducted efficiently and an inflator suitable for an air bag apparatus required to perform development of an air bag swiftly after impact detection, such as an inflator for an air bag for a side collision, an inflator for a curtain air bag or the like can be obtained. The diffuser member is formed as a separate member and formed such that it can be installed later on, and therefore the diffuser member can be dismounted during transportation and storage of inflators. Even if the inflator causes malfunction, when the first gas discharge ports are formed in the annular portion of the gas discharge portion evenly in the circumferential direction thereof, a propelling force due to a gas discharged is cancelled and the inflator can be prevented from jumping as a rocket. Then the inflator can be fitted at a predetermined position easily at mounting thereof in a vehicle or when it is assembled in a module case.

In particular, in addition to that the second gas discharge port formed in the passage forming portion can be formed as one opening, two or more openings can be formed on one portion of a peripheral face of the passage forming portion unevenly. In the latter case, a group of the second gas discharge ports comprising plural openings are formed such that the openings are close to one another and the total opening area of the openings is equal to or more than a case that one opening is provided.

Further, it is desirable that the passage defined by the gas discharge portion and the passage forming portion is formed to have such a communication sectional area that the force of the gas exhausted from the first gas discharge ports is not damped, and it is also desirable that the second gas discharge port(s) is formed to have such an opening area that the force of the gas exhausted from the first gas discharge ports is not damped. By defining the total opening area of the first gas discharge ports and the second gas discharge port(s) in this manner, an ejecting pressure of the gas can be controlled by the first gas discharge ports. Accordingly, it is desirable that the pressure loss of the first gas discharge ports is larger than the pressure loss of the second gas discharge port(s).

Thus, in the inflator of the present invention, a gas for inflating an air bag is discharged evenly in a direction orthogonally to the axial direction of the inflator housing, but a large-scaled deflection mechanism of a gas flow for converging the ejecting direction of a gas in one direction inside the module case to feed the gas into an air bag like the conventional art is not required. For this reason, even if an installation space is smaller, an air bag apparatus using the inflator of the present invention can be installed.

In the above invention, the passage forming portion of the diffuser portion comprises two projecting portions projecting outwardly in the radial direction along the circumferential direction of the gas discharge portion and an annular portion formed between the two projecting portions integrally therewith, and it is preferable that the second gas discharge ports are formed unevenly on one portion of a peripheral face of the annular portion. Thereby, a passage through which a gas passes at activation, namely, a passage defined by the passage forming portion and the gas discharge portion can be formed easily.

Further, in the above invention, it is desirable that a step portion formed along the circumferential direction is provided on the outer peripheral face of the gas discharge portion and the diffuser member is provided with an engagement portion engaged with the step portion complementarily. That is, the step portion formed on the outer peripheral face of the gas discharge portion is provided with a step difference which makes a round on at least the outer peripheral face of the gas discharge portion, such as a groove or a projection which extends in the circumferential direction of the outer peripheral face of the gas discharge portion to make one round continuously on the circumferential face. On the other hand, it is desirable that the engagement portion of the diffuser member (one portion of an inner peripheral face of the diffuser member) is formed with such a step difference complementarily engaged with the step difference formed at the step portion of the gas discharge portion. With such a formation, the step portion formed on the gas discharge portion and the engagement portion formed on the diffuser portion are complementarily engaged with each other, and therefore the diffuser member can be mounted to the gas discharge portion easily by pressure-fitting or the like. This is preferable, especially, as compared with a case that the diffuser member is joined by welding or the like, because manufacturing steps can be simplified, there is no influence of welding heat and so on. Especially, in the case that the diffuser member is mounted to the gas discharge portion by welding at mounting of the inflator to the module case, when there is an igniter near the gas discharge portion, there is a possibility that malfunction of the igniter occurs due to the welding heat. Further, as the step portion is formed to make a round along the circumferential direction on the outer peripheral face of the gas discharge portion, once the diffuser member is engaged with the gas discharge portion, the diffuser member becomes hard to fall off in the axial direction thereof. Further, the engagement portion of the diffuser member can be utilized as an extension portion shown below. The step portion in the present invention is required to be formed to have at least the step difference, and this portion may be formed as the groove or the projection, as described above, and it maybe formed to have a step difference, for example, in a crank shape.

In particular, it is desirable that the projecting portion forming the passage forming portion of the diffuser member is integrally formed with an extension portion having an annular portion extending in the axial direction of the gas discharge portion and a nut-like member is threadly attached with an outer peripheral face of the annular portion of the extension portion in a threading manner, thereby defining a space between the nut-like member and the projecting portion as an air bag clamping and fixing portion. The air bag can be fixed directly by the air bag clamping and fixing portion, and therefore an air bag apparatus (an entire system) formed using this inflator becomes more compact. The nut-like member may be provided with such an aspect that it can be threadly attached to a screw threading formed on an outer peripheral face of the annular portion of the extension portion, and it is not limited to a nut necessarily.

Moreover, it is preferable that nut-like members are threadly attached to outer peripheral faces on both sides of the diffuser portion in the axial direction thereof and annular projecting portions existing on both sides of the second gas discharge port in axial direction thereof are provided, and a space between each nut-like member and a corresponding annular projecting portion is defined as the air bag clamping and fixing portion. For example, the extension portion is formed integrally regarding each of the two projecting portions forming the passage forming portion so that a space between the nut-like member screwing on the outer peripheral face of the annular portion of each extension portion and the projecting portion can be defined as the air bag clamping and fixing portion. Thereby, an inflator which can be fixed with an air bag further simply is achieved.

In the above invention, the inflator housing is formed in a cylindrical shape and symmetrically regarding its axial direction and widthwise direction, so that workability during manufacturing can be improved.

Further, the present invention provides, as a means for solving the above problem, an air bag apparatus constituted to include an activation signal-outputting means comprising an impact sensor and a control unit, an inflator for an air bag which receives an activation signal outputted from the activation signal-outputting means to be activated to discharge a gas, and an air bag which introduces a gas discharged from the inflator for an air bag therein to be inflated, wherein, as the inflator for an air bag, the above inflator for an air bag is used, and the air bag is provided to develop in the ejecting direction of a gas at the second gas discharge ports provided in the inflator for an air bag.

In the air bag apparatus thus formed, the air bag can be developed efficiently by the gas exhausted from the second gas discharge port. Further, an end portion of the air bag is prevented from coming off from its fixed position due to an impact at developing of the air bag.

According to the inflator of the present invention, assembling work can be made easy and a burden on a worker can be reduced, and a connecting force at connection with an air bag can be elevated.

### BRIEF DESCRIPTION OF THE DRAWINGS

FIG. 1 is a lengthwise sectional view of an embodiment of an inflator of the present invention;

FIG. 2 is a view for explaining a mounting state of the inflator with an air bag in FIG. 1;

FIG. 3 is a lengthwise sectional view of an inflator of another embodiment; and

FIG. 4 are schematic views showing an inflator of still another embodiment, FIG. 4(a) being a perspective view of a principal portion and FIG. 4(b) being a sectional view taken along A-A line.

### DESCRIPTION OF NUMERALS

10 inflator

12 inflator housing

18 outflow route

20 gas discharge portion

22 first gas discharge port

25 igniter

29 filter

30 O-ring

31 step portion

40 diffuser member

41 engagement portion

42a, 42b projecting portion

43 annular portion

44 extension portion

45 second gas discharge port

46 gas passage

47 nut-like member

48 clamp

50 passage forming portion

60 annular projecting portion

B air bag

### PREFERRED EMBODIMENT OF THE INVENTION

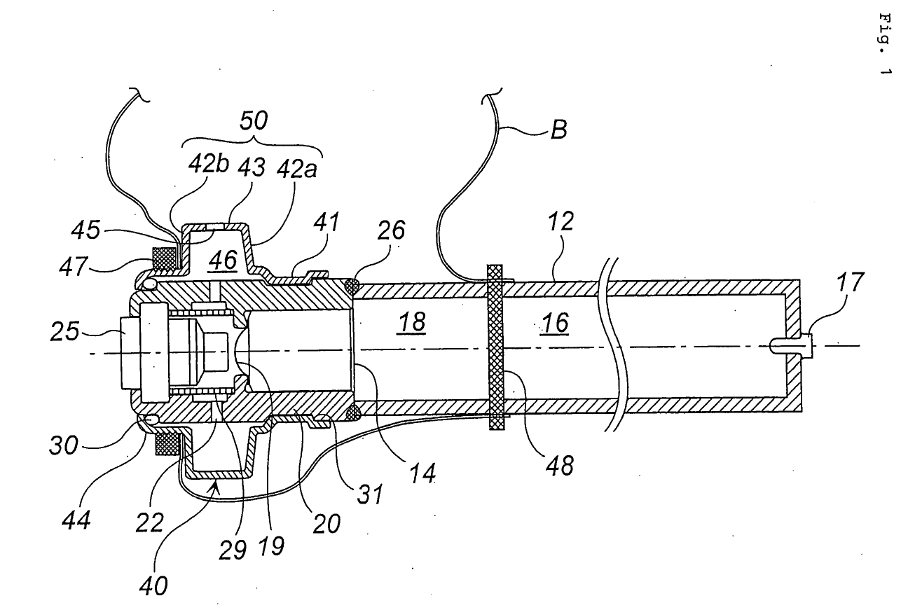

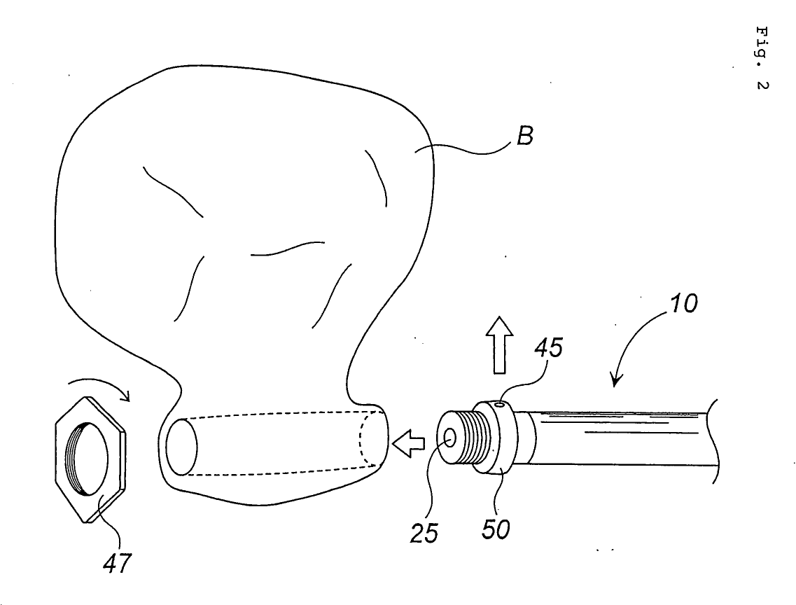

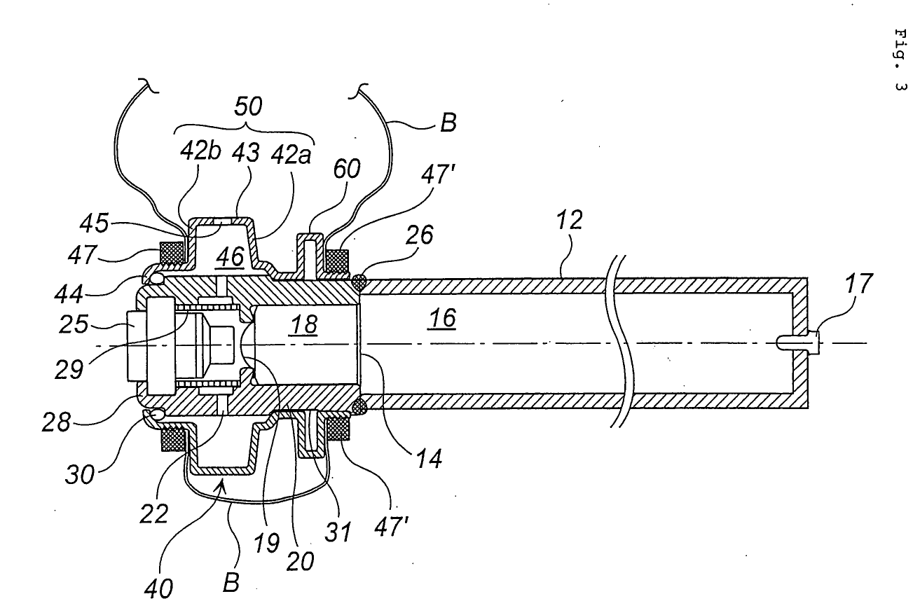

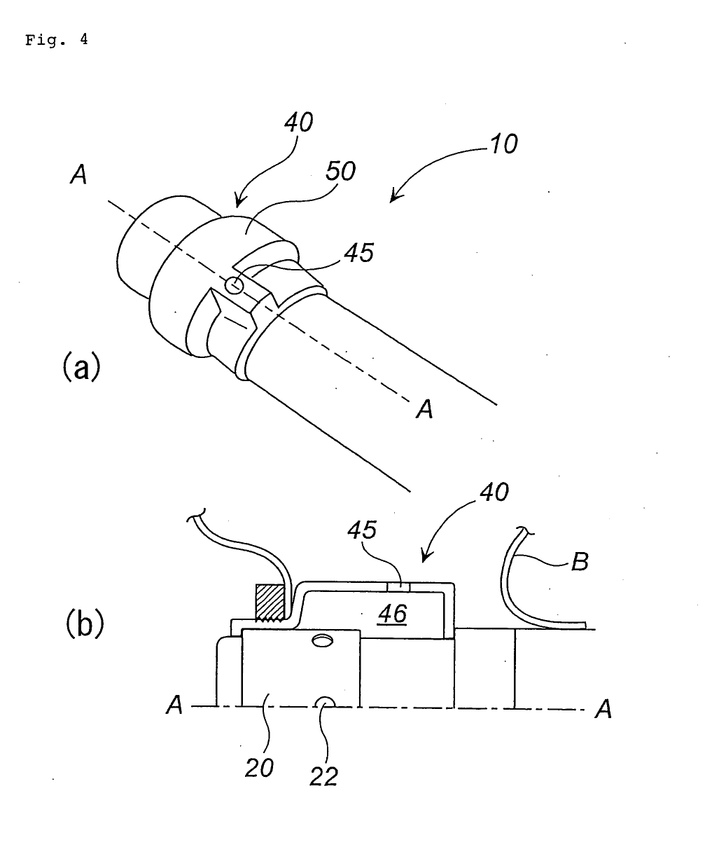

One embodiment of the present invention will be explained below with reference to the drawings. FIG. 1 is a lengthwise sectional view in an embodiment of an inflator of the present invention, FIG. 2 is a view for explaining a mounting state of the inflator with an air bag, FIG. 3 is a lengthwise sectional view showing an inflator of another embodiment, and FIG. 4 are schematic views showing still another embodiment, FIG. 4(a) being a perspective view of a principal portion and FIG. 4(b) being a sectional view taken along A-A line.

In particular, an inflator showing this embodiment is an aspect using a pressurized gas as a gas source for inflating an air bag (B), and it is especially suitable for an inflator for a curtain air bag or an inflator for a side air bag.

In an inflator shown in FIG. 1, an inflator housing 12 has an opening portion 14 at one end, and the other end closed. The inner space 16 thereof is charged with a pressurized medium comprising an inert gas such as argon, helium, nitrogen or the like at the maximum pressure of about 60,000 kPa. The inflator housing 12 has a circular section in the widthwise direction and similarly the opening portion 14 is also circular.

The inflator housing 12 has a symmetrical shape regarding the axial direction and the widthwise direction thereof. After a gas discharge portion 20 is connected to the inflator housing 20, a pressurized medium is charged from a clearance between a thin hole provided at the other end of the housing 12 and a sealing pin 17 inserted in the thin hole. Thereafter, the other end of the inflator housing 12 is welded at a portion of the sealing pin 17 to be closed completely.

The opening portion 14 of the inflator housing 12 is connected with the gas discharge portion 20, and the gas discharge portion 20 is formed with first gas discharge ports 22 for directing the pressurized medium to flow outside evenly along the circumferential direction. The first gas discharge ports 22 are not closed and a filter 29 comprising an annular wire-mesh for eliminating fragments of a rupturable plate 19 is arranged inside the first gas discharge ports 22.

The inflator housing 12 and the gas discharge portion 20 may be connected by welding (at a welded portion 26), as shown in FIG. 1. Alternatively, a male screw portion is provided on an outer peripheral face of an end portion of the inflator housing 12 and a female portion is provided on an inner peripheral face of an end portion of the gas discharge portion 20 so that connection may be made by screwing the male portion and the female portion.

An outflow route 18 for the pressurized medium between the opening portion 14 of the inflator housing 12 and the gas discharge portion 20 is closed by a rupturable plate 19, and the inner space 16 of the inflator housing 12 is maintained in a high pressure air-tight condition before activation. In FIG. 1, the rupturable plate 19 is mounted at the side of the gas discharge portion 20, but it may be mounted at the side of the opening portion 14 of the inflator housing 12.

The gas discharge portion 20 is provided with an igniter 25 including a priming as a rupturing means for the rupturable plate 19. The igniter 25 is mounted after connection of the inflator housing 12 and the gas discharge portion 20, it is fitted in the direction from an opening portion (an opening portion on the left side on the drawing) at one end of the gas discharge portion 20 toward the rupturable plate 19, and it is fixed by crimping a peripheral edge 28 of the opening portion of the gas discharge portion 20 at the one end after fitted. The igniter 25 and the rupturable plate 19 are mounted on an axis coaxial to the central axis of the inflator housing 12, and the rupturable plate 19 is ruptured by activation of the igniter 25 so that the pressurized gas charged inside the inner space 16 is released and discharged.

A diffuser member 40 is mounted to the gas discharge portion 20 to cover an outer surface including the first gas discharge portions 22. The diffuser member 40 is formed with an engagement portion 41 provided on the side of the inflator housing 12 in the lengthwise direction thereof, an annular portion 43 provided at a central portion in the lengthwise direction, projecting portions 42a and 42b formed on both sides of the annular portion 43 in the lengthwise direction, and an extension portion 44 formed on the opposite side to the engagement portion 41 in the lengthwise direction. That is, the diffuser member 40 is formed such that the engagement portion 41, the projecting portion 42a, the annular portion 43, the projecting portion 42b and the extension portion 44 are connected in series from the inflator housing 12, and among them, the annular portion 43 and the projecting portions 42a and 42b constitute a passage forming portion 50. The diffuser member 40 is formed as a singular separate member in this manner and it is fixed at a groove formed in the gas discharge portion, namely, a step portion 31 by crimping the engagement portion 41 (in this connection, the step portion can be formed by forming a projecting portion too).

In FIG. 1, a screw threading is formed on an entire outer periphery of the extension portion 44, namely up to the connection portion (a bent portion) with the projecting portion 42b, and the screw threading is threadly attached with a nut-like member 47 (a nut in this embodiment). As the threadly attached nut-like member 47 can be fastened until it abuts against the projecting portion 42b, an end portion opening of the air bag (B) can be clamped between the nut-like member 47 and the projecting portion 42b, as illustrated. That is, a space between the nut-like member 47 and the projecting portion 42ba functions an air bag clamping and fixing portion. When the air bag (B) is fixed to the inflator by providing such an air bag clamping and fixing portion, the one end opening of the air bag (B) is clamped at the air bag clamping and fixing portion between the nut-like member 47 and the projecting portion 42b to be fixed easily and reliably and the connection force between the air bag (B) and the inflator 10 is increased by inserting the gas discharge port side of the inflator into an opening, of the air bag (B) as illustrated in FIG. 2, and fastening the nut-like member 47 on the entire outer periphery of the extension portion 44.

In this connection, as shown in this FIG. 1, when the nut-like member 47 is threadly attached to only the side of the extension portion 44 and the number of the air bag clamping and fixing portion provided is one, the other opening in the air bag (B) is fixed by clamp 48, as illustrated.

In view of these circumstances, in order to omit fixation conducted by the such a clamp 48 and fix the air bag (B) more easily, as shown in FIG. 3, an annular projecting portion 60 projecting in a flange shape is formed on a portion of the diffuser portion 40 which is positioned on the side of the inflator housing 12 and a nut-like member 47′ is threadly attached to a portion of the diffuser portion which is closer to the inflator housing 12 than the projection, so that a space between the nut-like member 47′ and the annular projecting portion 60 can also be defined as the air bag clamping and fixing portion. In this case, all the openings in the air bag (B) are eventually fixed to the air bag clamping and fixing portions.

A gas passage 46 comprising an outer peripheral face of the gas discharge portion 20, the projecting portions 42a and 42ba, and the annular potion 43 is formed between the outer peripheral face of the gas discharge portion 20 and the diffuser member 40. For this reason, the pressurized medium ejected from the plural first gas discharge ports 22 flows in the gas passage 46 to entirely flow towards the second gas discharge ports 45 so that it is ejected from the second gas discharge port 45. Then the second gas discharge ports 45 are formed on one portion of the passage forming portion 50 unevenly in the circumferential direction, so that the gas exhausted from the inflator is concentrated in one direction to be ejected. Thereby, an inflator which can develop the air bag (B) efficiently is achieved.

Then, because the diffuser member 40 is formed as a separate member, the inflator of the present invention can be stored and transported as an inflator product in a state having the igniter 25 assembled therein, and even if malfunction occurs at that time, a propelling force is cancelled so that the inflator itself is prevented from being scattered, because the first gas discharge ports 22 are formed evenly on the peripheral face of the gas discharge portion 20. Then, by mounting the diffuser member 40 in the present invention to the gas discharge portion just before assembling into the module, a gas for inflating the air bag can be concentrated. Mounting of the diffuser member 40 can be performed by fitting the projection of the engagement portion 41 to the step portion 31 of the gas discharge portion complementarily, and therefore the mounting can be performed easily and connection with the air bag can be conducted easily.

In particular, in formation of a second gas discharge port, as further shown in FIG. 4, the second gas discharge port may be formed to be deviated from the first gas discharge ports. That is, one portion of the gas passage is extended in the axial direction of the diffuser member 40 and the second gas discharge port is formed on the extended portion of the gas passage. As shown in this FIG. 4, when a formation position of the second gas discharge port is positioned at a center of the gas introducing port in the air bag (B), the air bag (B) can be inflated more efficiently and safely.

It is preferable that the diameter of the first gas discharge port 22 is made to be smaller than the diameter of the second gas discharge port 45. Even when these ports are respectively provided plural, size setting is conducted in the same manner as the above.

In order to prevent the inflator 10 from jumping out like a rocket at malfunction, it is preferable regarding the first gas discharge port that plural first gas discharge ports 22 are provided, for example, evenly in the circumferential direction of the gas discharge portion. By arranging the first gas discharge ports in this manner, the inflator is prevented from jumping as a rocket even if malfunction occurs before mounting the diffuser portion 40.

In mounting the diffuser member 40, the diffuser member 40 is fitted into the gas discharge portion 20 from the side of the igniter 25 and adjustment is made such that the engagement portion 41 and the step portion 31 correspond to each other. At this time, an end portion of the diffuser portion positioned at the side where the igniter is provided is directed to abut against a portion of the gas discharge portion 20 positioned near the opening edge 28, and an O-ring 30 is disposed at the abutting portion for maintaining air-tightness. Thereafter, the diffuser member is fixed to the step portion 31 by crimping an end portion of the diffuser member 40 positioned on the side of the igniter, as shown in FIG. 1.

Next, an operation of the air bag apparatus using the inflator 10 will be explained with reference to FIG. 1. When a vehicle receives an impact, the igniter 25 receives a signal from the impact sensor to be activated, and the priming is ignited and burnt so that the rupturable plate 19 is ruptured. As the opening portion 14 is opened by rupturing of the rupturable plate 19, after the pressurized medium inside the inner space 16 flows in the gas passage 46 from the plural first gas discharge ports 22 via the outflow route 18 and the filter 29, the gas reaches the second gas discharge port 45 through the gas passage 46 to be ejected from the second gas discharge port 45, thereby inflating the air bag (B). At this time, fragments of the rupturable plate 19 are eliminated by the filter 29.

The air bag apparatus using the inflator 10 is constituted by combining an activation signal-outputting means comprising an impact sensor and a control unit, a module case where the inflator 10 and an air bag (B) (for example, a curtain-like air bag) are accommodated and the like, and it may have the same constitution as the one shown in FIG. 17 of JP-A 11-334517.

1. An inflator for an air bag constituted to include
an inflator housing which accommodates at least one of a pressurized gas and a gas generating agent which burns to generate a gas,
a gas discharge portion provided with an annular portion formed with plural first gas discharge ports for discharging a gas of the inflator housing, and
a diffuser member which covers an outer surface of the gas discharge portion and is mounted as a separate member only in the vicinity of the first gas discharge ports, wherein
the diffuser member is provided with a passage forming portion for guiding a gas discharged from the first gas discharge ports in the circumferential direction of the gas discharge portion between the diffuser member and the gas discharge portion, and one or two or more second gas discharge ports for discharging the gas of the passage in the radial direction of the inflator housing are formed unevenly on the one portion of the passage forming portion in the circumferential direction.

2. An inflator for an air bag according to claim 1, wherein the passage forming portion of the diffuser portion comprises two projecting portions projecting outwardly in the radial direction along the circumferential direction of the gas discharge portion and an annular portion formed integrally between the two projecting portions, and the second gas discharge ports are formed unevenly on one portion of a peripheral face of the annular portion.

3. An inflator for an air bag according to claim 1, wherein a step portion formed along the circumferential direction of the gas discharge portion is provided on an outer peripheral face of the gas discharge portion, and
the diffuser member is provided with an engagement portion engaged with the step portion complementarily.

4. An inflator for an air bag according to claim 3, wherein a projecting portion forming the passage forming portion of the diffuser member is formed integrally with an extension portion having an annular portion extending in the axial direction of the gas discharge portion and is threadly attached with a nut-like member on an outer peripheral face of the annular portion of the extension portion, and a space between the nut-like member and the projecting portion is defined as an air bag clamping and fixing portion.

5. An inflator for an air bag according to claim 1 or 2, wherein the diffuser member is threadly attached with nut-like members on an outer peripheral face on both sides thereof in the axial direction thereof and is provided with annular projecting portions existing on both sides in the axial direction of the second gas discharge ports, and a space between each nut-like member and a corresponding annular projecting portion is defined as an air bag clamping and fixing portion.

6. An air bag apparatus constituted to include an activation signal-outputting means comprising an impact sensor and a control unit, an inflator for an air bag which receives an activation signal outputted from the activation signal-outputting means to be activated thereby discharging a gas, and an air bag which is inflated by introducing a gas discharged from the inflator for an air bag therein, wherein
as the inflator for an air bag, an inflator for an air bag according to claim 1 or 2 is used, and
the air bag is provided to the inflator for an air bag to develop in the ejecting direction of a gas at the second gas discharge ports provided in the inflator for an air bag.
